(19) United States
(12) Patent Application Publication
(10) Pub. No.: US 2007/0267839 A1
(43) Pub. Date: Nov. 22, 2007

(54) COMBINATION SPRING, SHOCK AND BRAKE CABLE BRACKET

(75) Inventors: Christopher K. Furman, Augusta, GA (US); James Agerton, Augusta, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/419,372

(22) Filed: May 19, 2006

(51) Int. Cl. B60G 15/00

(52) U.S. Cl. 280/124.147

(57) ABSTRACT

A suspension system for a golf car includes an axle housing having first and second brake drum/hubs rotatably supporting first and second driven wheels. A brake actuation arm is rotatably connected to each brake drum/hub. A bracket is connected to the axle housing. The bracket includes a first wall having a fastener receiving aperture, and an opposed second wall oriented at an angle with respect to the first wall. The second wall has a keyed aperture. A shock absorber is connected by a fastener to the fastener receiving aperture. A cable assembly has an outer sheath engaged with the second wall and a flexible cable slidingly disposed within the outer sheath and coupled to the brake actuation arm. A pin extending from a leaf spring is received in a bracket pin aperture. A further bracket aperture engages an assembly dolly.

### FIELD

The present disclosure relates to a device and method for connecting suspension and control elements, for example, in golf car and off-road utility vehicles.

### BACKGROUND

The statements in this section merely provide background information related to the present disclosure and may not constitute prior art.

Golf cars and many off-road or utility vehicles, hereinafter commonly have rigid or single axle suspension systems for both the front steerable wheels and the rear driving wheels. Rear suspensions for these vehicles commonly include leaf springs and/or shock absorber assemblies used to support the solid axle. Some golf car designs have therefore utilize leaf spring and shock absorber combinations to both stabilize the vehicle and to provide a more comfortable ride. The leaf springs are also relied on to promote side-to-side and bounce stability of the suspension. Shock absorbers dampen the leaf spring travel and frequency which therefore promote a more stable and comfortable ride feel. Braking systems are commonly independently supported with respect to the suspension components.

Component parts for golf cars are commonly connected to a frame as independent items during assembly. This results in multiple part connections, multiple connector elements, and multiple requirements for fasteners or welded joints. For cost and assembly time reduction purposes, it is desirable to reduce the number of component parts while providing structurally sound vehicles.

### SUMMARY

According to several embodiments of the present disclosure, a bracket for a golf car suspension system includes a face plate. First and second opposed side walls extend from the face plate. A mounting wall extends from the face plate operable to connect the first and second side walls. A nut is welded to the mounting wall and is coaxially aligned with a fastener aperture created in the mounting wall. The nut and the fastener aperture receive a threaded fastener. An arc face created in each of the first and second side walls engages an axle housing, each arc face corresponding to a diameter of the axle housing.

According to other embodiments, a bracket for a golf car suspension system includes a face plate, first and second opposed side walls extending from the face plate, and a mounting wall extending from the face plate to connect the first and second side walls. An extending wall extends from the face plate opposite to the mounting wall and is angularly oriented with respect to both the face plate and the mounting wall. A retaining wall is positioned at distal ends of the first and second side walls. A keyed aperture created in the retaining wall receives a flexible cable.

According to other embodiments, a golf car suspension system includes first and second shock absorbers each having a mounting sleeve. First and second brackets configured as mirror images of each other include a face plate and a mounting wall extending from the face plate including a fastener receiving aperture aligned with the mounting sleeve of one of the shock absorbers. An extending wall positioned opposite to the mounting wall is angularly oriented with respect to both the mounting wall and the face plate. A retaining wall positioned at a distal end of the extending wall is oriented at an angle with respect to the mounting wall. A keyed aperture is created in the retaining wall. First and second fasteners are each inserted through the fastener receiving aperture of one of the first and second brackets and the mounting sleeve of one of the first and second shock absorbers.

According to still other embodiments, a suspension system for a golf car includes an axle housing having first and second wheel hub brake drum. A brake actuation arm is rotatably connected to each wheel hub brake drum. A bracket is connected to the axle housing. The bracket includes a first wall having a fastener receiving aperture, and an opposed second wall oriented at an angle with respect to the first wall. The second wall has a keyed aperture. A shock absorber is connected by a fastener to the fastener receiving aperture of the bracket. A cable assembly has an outer sheath engaged with the second wall and a flexible cable slidingly disposed within the outer sheath and coupled to the brake actuation arm. A pin extending from a leaf spring is received in a bracket pin aperture. A further bracket aperture engages an assembly dolly.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a golf car having the combination spring, shock and brake cable brackets according to various embodiments;

FIG. 2 is a bottom plan view of the golf car of FIG. 1;

FIG. 3 is a perspective view of an axle and axle gear housing assembly having the combination brackets of the present disclosure;

FIG. 4 is a partial perspective view of a shock absorber/leaf spring assembly connected to a combination bracket according to various embodiments;

FIG. 5 is a top plan view of the assembly of FIG. 3;

FIG. 6 is a bottom plan view of the assembly of FIG. 3;

FIG. 7 is an end elevational view of the assembly of FIG. 3;

FIG. 8 is a perspective view of a combination bracket of the present disclosure;

FIG. 9 is a side elevational view of the combination bracket of FIG. 8;

FIG. 10 is a top plan view of the combination bracket of FIG. 8; and

FIG. 11 is an end elevational view of the combination bracket of FIG. 8.

### DETAILED DESCRIPTION

The following description is merely exemplary in nature and is in no way intended to limit the present disclosure, application, or uses. Throughout this specification, like reference numerals will be used to refer to like elements. As referred to herein, the term “golf car” is synonymously used to describe application of the present disclosure to golf cars as well as sport utility vehicles such as modified golf cars, used for example as food and/or beverage cars, golf cars adapted for use as hunting/sporting clays vehicles, golf course maintenance vehicles, and the like.

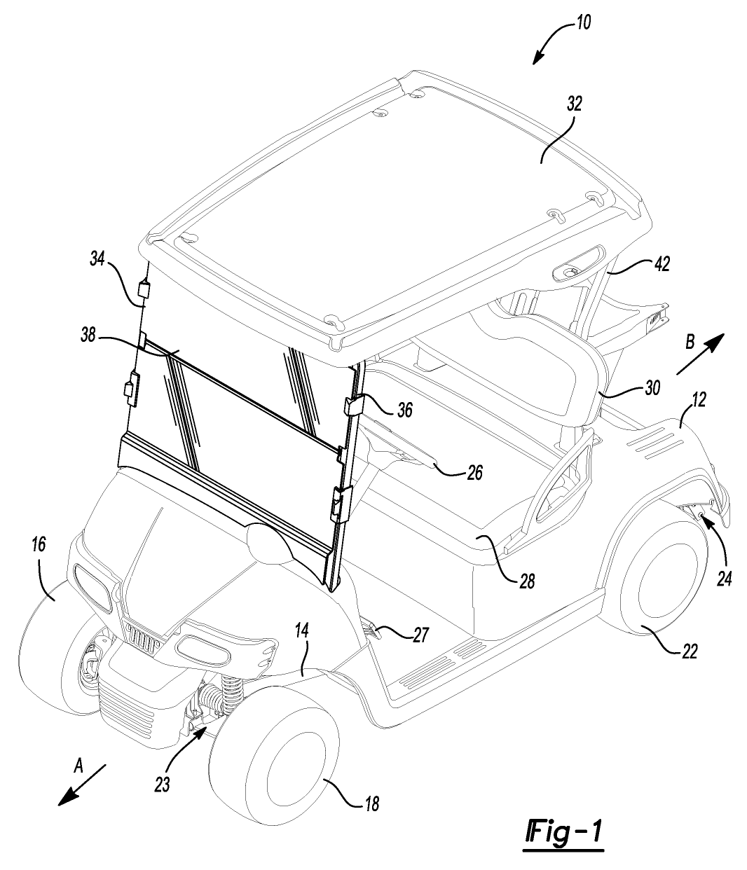

Referring generally to FIG. 1, a golf car 10 can include a body 12 supported from a structural frame 14. Frame 14 can also support a plurality of wheels including a first steerable wheel 16 and a second steerable wheel 18. In addition, powered or driven wheels including a first driven wheel 20 and a second driven wheel 22 are commonly connected to a rear structural portion of frame 14. A front suspension system 23 can also be provided which is adapted for supporting each of the first and second steerable wheels 16, 18. A rear suspension system 24 can also be provided which is adapted for supporting each of the first and second driven wheels 20, 22. A steering mechanism 26 which commonly includes a steering wheel and a support post assembly is also included to provide the necessary steering input to first and second steerable wheels 16, 18. A brake pedal 27 can also be provided in the operator area to slow or stop golf car 10.

Golf car 10 can also include a passenger bench seat 28 and a passenger back support cushion 30. A cover or roof 32 can also be provided which is supported from either body 12 or frame 14 by first and second support members 34, 36. A windscreen or windshield 38 can also provided which is also supported by each of first and second support members 34, 36. A rear section of roof 32 can be supported by each of a first and a second rear support element 40, 42. Other items provided with golf car 10 include golf bag support equipment, accessory racks or bins, headlights, side rails, fenders, and the like.

Golf car 10 is commonly propelled by a power unit such as an engine or battery/motor system which is commonly provided below and/or behind bench seat 28. Golf car 10 is capable of motion in either of a forward direction “A” or a rearward direction “B”. Each of first and second driven wheels 20, 22 can be commonly supported to frame 14 using rear suspension system 24. Each of first and second steerable wheels 16, 18 can be independently or commonly supported to frame 14, therefore the present disclosure is not limited by the design of front suspension system 23.

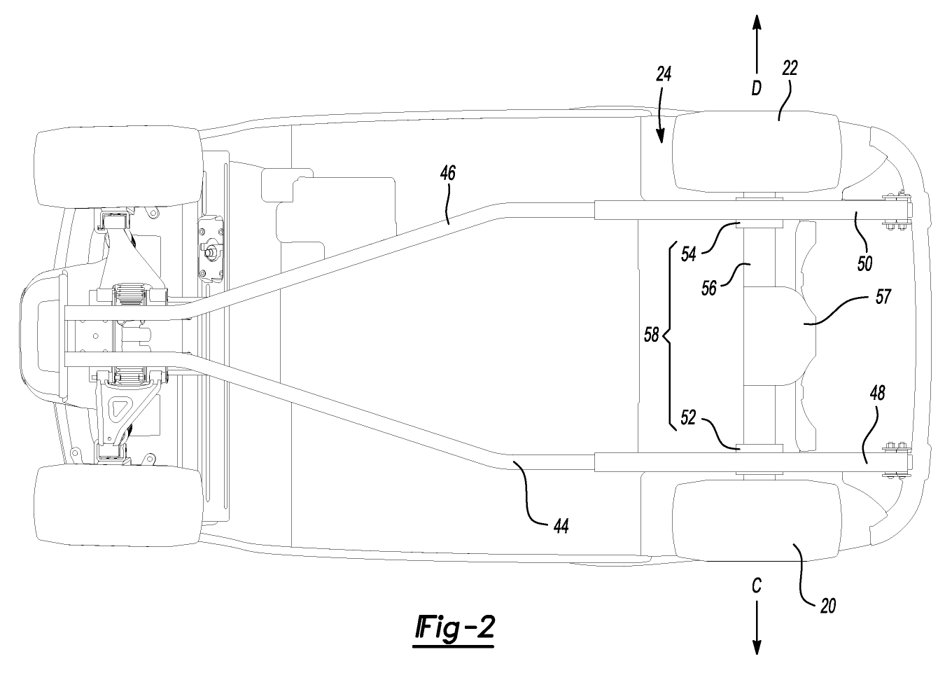

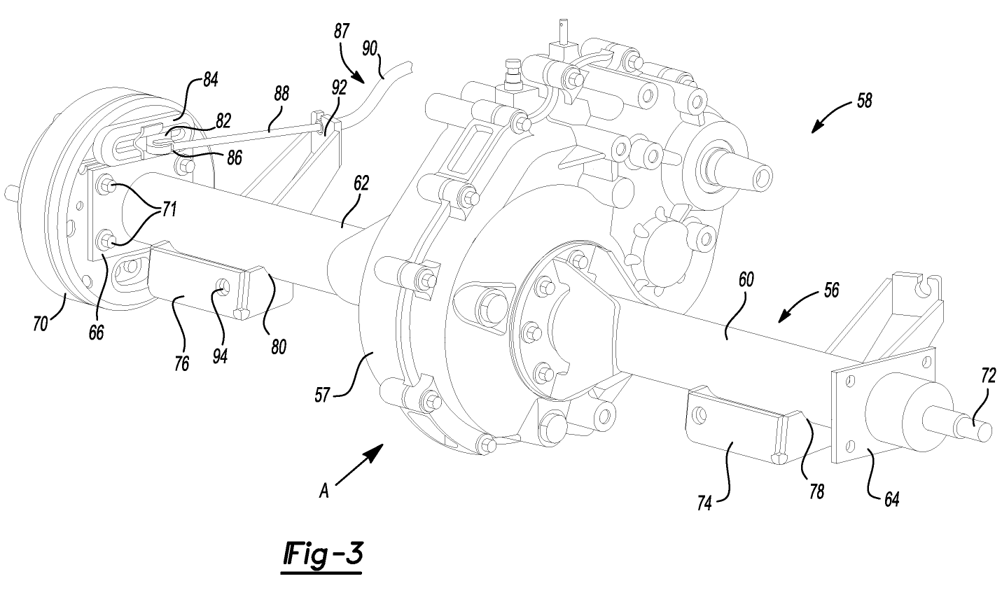

As best seen in reference to FIG. 2, frame 14 can further include a longitudinally arranged first frame member 44 and a second frame member 46. First and second frame members 44, 46 can be hollow, tubular shaped members created of a steel material or similar structural material and formed by welding, extruding, hydroforming, or similar processes. A first and second leaf spring 48, 50 support each of first and second driven wheels 20, 22. First and second leaf springs 48, 50 also help restrain side-to-side suspension deflection such as in either first and/or second deflection directions “C” and “D”. A first shock assembly 52 can be connected to a first leaf spring 48 and first frame member 44. Similarly, a second shock assembly 54 can be connected to second leaf spring 50 and second frame member 46. Each of first and second shock assemblies 52, 54 are also connected to an axle housing 56 within which an axle (shown in FIG. 3) is rotatably disposed for providing driving power to the first and second driven wheels 20, 22 through a gear train or axle gear housing 57 connected to the power unit. Axle housing 56 and axle gear housing 57 in part create a rear drive assembly 58.

Referring now to FIG. 3, multiple components of the rear drive assembly 58 include axle gear housing 57 which divides axle housing 56 into each of a first housing portion 60 and a second housing portion 62. At a distal end of first housing portion 60 a first brake drum/hub mounting plate 64 is fixedly connected such as by welding. At a distal end of second housing portion 62 a second brake drum/hub mounting plate 66 is similarly provided. First and second brake drum/hub mounting plates 64, 66 each have one of a first or second brake drum/hub 68, 70 connected to the mounting plate for example using a plurality of fasteners 71. An axle 72 is rotatably disposed in axle housing 56 which is rotated by axle gear housing 57 to provide the rotating drive force for first and second driven wheels 20, 22.

According to several embodiments, a first combination bracket 74 is connected to first housing portion 60 and a second combination bracket 76 is connected to second housing portion 62. Each of the first and second combination brackets 74, 76 are fixed in place for example using a plurality of each of first weld joints 78 and second weld joints 80. First and second combination brackets 74, 76 perform multiple functions which will be described hereinafter.

Each of the first and second brake drum/hubs 68, 70 are provided with a brake actuation arm 82 (only one is shown in FIG. 3 for clarity) which is slidably received in a receiver 84 of the appropriate brake drum/hub. A first function of the first and second combination brackets 74, 76 includes providing support for the mechanical actuation of brake actuation arms 82. To accomplish this, a fastener 86 such as a toggle fastener is connected to brake actuation arm 82. A cable assembly 87 includes a flexible cable 88 fixed to fastener 86. Flexible cable 88 is slidably received within a cable sheath 90. A portion 91 of flexible cable 88 extends outwardly from cable sheath 90. Cable sheath 90 is therefore fixed in position with respect to a retaining wall 92 of second combination bracket 76 to permit the sliding displacement of flexible cable 88 without longitudinal motion of cable sheath 90. Opposite distal ends of cable assembly 87 including each of flexible cable 88 and cable sheath 90 are similarly disposed proximate to a brake pedal (not shown) provided for operation by an occupant of golf car 10. Actuation of the brake pedal 27 causes flexible cable 88 to displace (to the right as viewed in FIG. 3) which actuates brake actuation arm 82. Additional items such as biasing elements and/or tensioning devices (not shown) can also be provided to bias brake actuation arm 82 toward a non-engaged braking position or to maintain a tension on flexible cable 88. A similar configuration of a cable sheath 90 and flexible cable 88 can be connected to first combination bracket 74 but are not shown in this view for clarity.

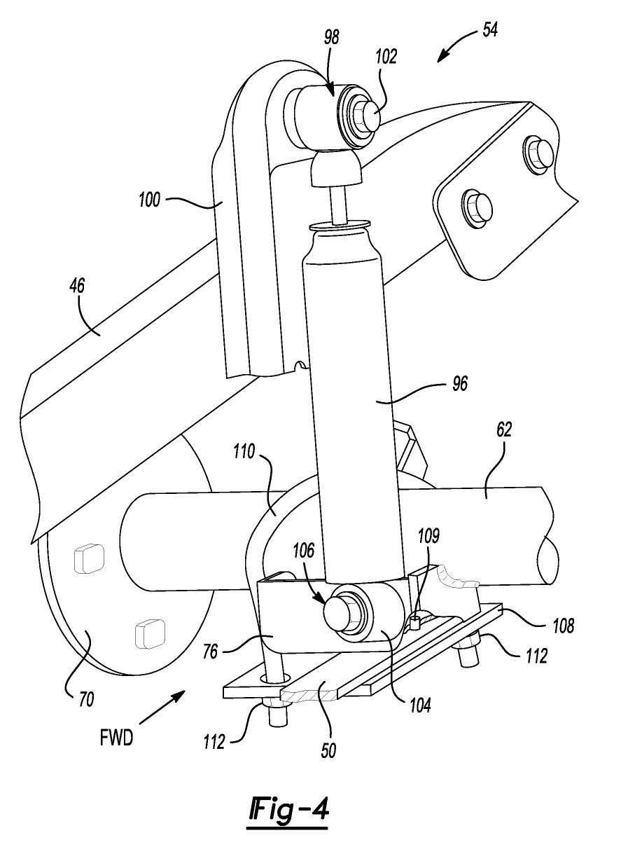

As best seen in reference to FIG. 4, details of second shock assembly 54 are provided, however it will be evident that a similar configuration for first shock assembly 52 having a mirror image arrangement can be provided for the opposite side of golf cart 10. Second shock assembly 54 both connects and provides deflection capability between second frame member 46 and second housing portion 62 of axle housing 56. Second shock assembly 54 includes a shock absorber 96 having a first mounting sleeve 98 connected to a frame extension 100 using a bolt 102. At an opposite end of shock absorber 96, a second mounting sleeve 104 is connected to second combination bracket 76 using a bolt 106. Bolt 106 is received within a fastener aperture 94 better seen in reference to FIG. 3. A similar fastener receiving aperture (not visible in this view) is provided in frame extension 100 to receive bolt 102.

Second leaf spring 50 is sandwiched between second combination bracket 76 and a support plate 108. An alignment pin 109 connected to each leaf spring is received in a pin receiving aperture (described in reference to FIG. 6) of each of first and second combination brackets 74, 76. Alignment pins 109 retain the orientation of both first and second leaf springs 48, 50 with respect to first and second combination brackets 74, 76. A U-bolt 110 is engaged with second housing portion 62 and support plate 108 using nuts 112. When nuts 112 are torqued, a physical coupling is created between support plate 108, second leaf spring 50, and second combination bracket 76. First and second combination brackets 74, 76 therefore at least provide the functions of retaining a brake cable, supporting a shock absorber, and supporting and restricting movement of a leaf spring.

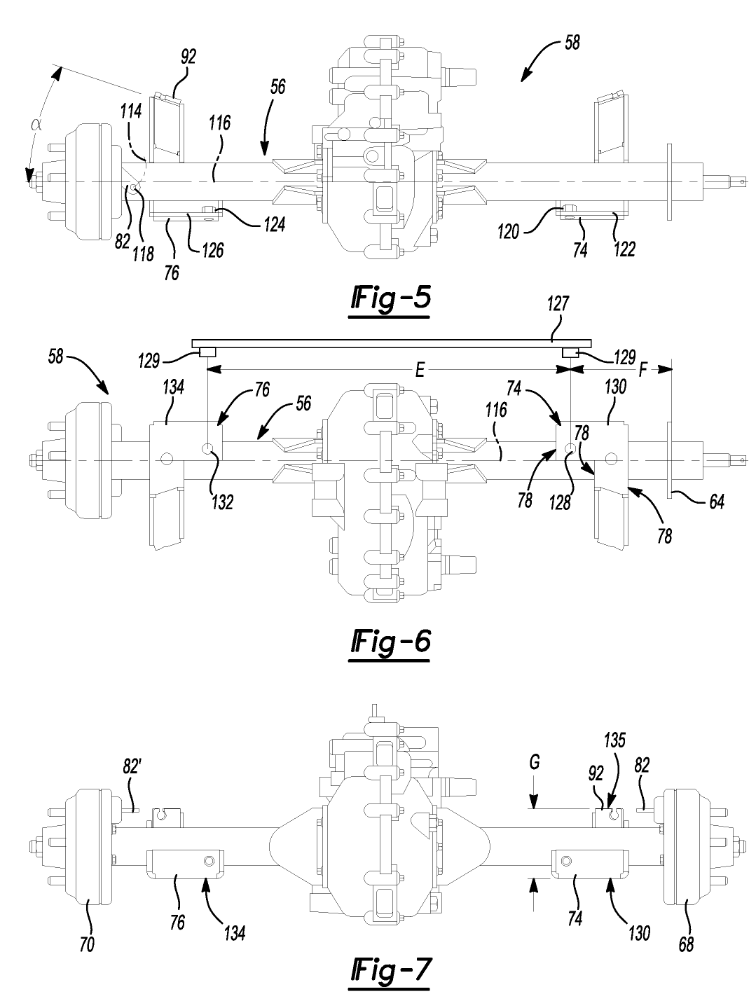

Referring now generally to FIG. 5, each brake actuation arm 82 deflects about an arc of rotation 114. A maximum rotation force can be applied by flexible cable 88 to brake actuation arm 82 by positioning flexible cable 88 substantially transverse to a longitudinal orientation of brake actuation arm 82 throughout a majority of the arc of rotation 114. To provide this orientation of flexible cable 88, retaining wall 92 is fixedly positioned with respect to a longitudinal axis 116 of axle housing 56 at an angle α. Angle α can vary depending on the length and arc of rotation of brake actuation arms 82. Angle α is therefore predetermined by the designer to suit a particular application of golf car 10. As further seen in reference to FIG. 5, a nut 120 such as a weld nut is fixedly connected such as by a tack weld to a first mounting wall 122 of first combination bracket 74. Similarly, a nut 124 is fixedly connected to a second mounting wall 126 of second combination bracket 76. Nuts 120, 124 threadably receive bolts 106 to connect shock absorber 96 to one of the first or second combination brackets 74, 76. It will be evident that first combination bracket 74 is a mirror image of second combination bracket 76 in several embodiments.

Referring now to FIG. 6, in order to assist in the assembly of golf car 10, an assembly dolly 127 can be used which supports the rear drive assembly 58 for subsequent installation of additional components. To accomplish this, a first alignment aperture 128 is created in a first face plate 130 of first combination bracket 74. Similarly, a second alignment aperture 132 is created in a second face plate 134 of second combination bracket 76. A spacing dimension “E” is maintained between each of first and second alignment apertures 128, 132. A reference dimension “F” determines a relative position for both first and second combination brackets 74, 76 with respect to a fixed reference point, for example first wheel mounting plate 64. Locating pins 129 extending from the assembly dolly 127 are received in each of first and second alignment apertures 128, 132 to support the rear drive assembly 58. The plurality of both first and second weld joints 78, 80 (second weld joints 80 not shown for clarity) maintain the orientation of first and second combination brackets 74, 76 with respect to axle housing 56. First and second combination brackets 74, 76 therefore perform the additional function of assisting in the assembly of golf car 10.

Referring now to FIG. 7, to ensure that the proper alignment between flexible cable 88 and either of the brake actuation arms 82, 82′ is maintained, a height “G” is maintained between an end face 135 of retaining wall 92 of both first and second combination brackets 74, 76 and both actuation arms 82, 82′. Height “G” is maintained with respect to first face plate 130 of first combination bracket 74 and second face plate 134 of second combination bracket 76.

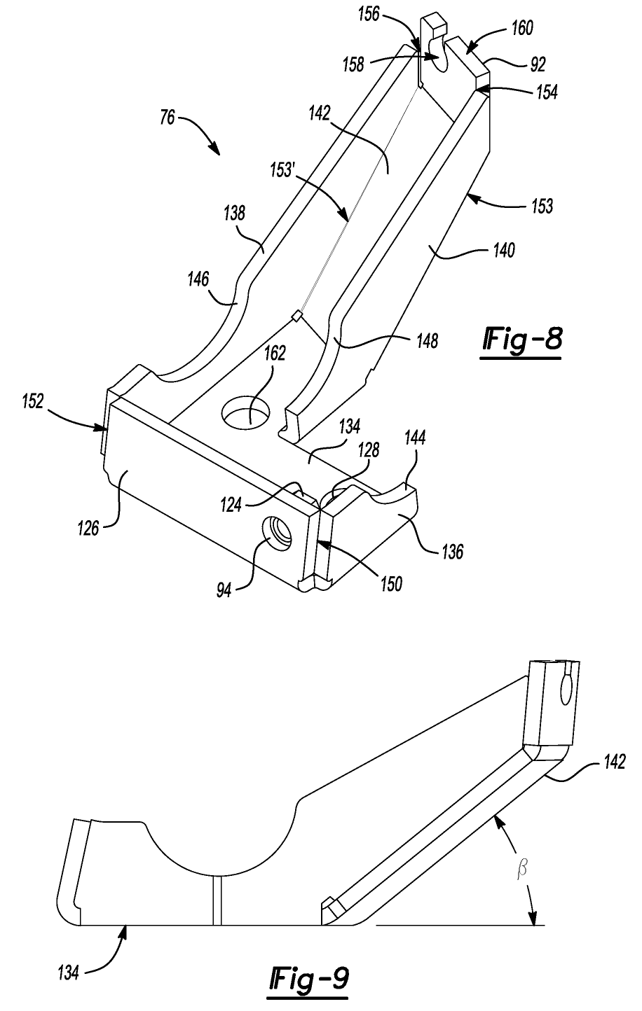

With reference to FIGS. 8 through 11, exemplary features of second combination bracket 76 which are common (in a mirror image configuration) with first combination bracket 74 include a first side wall 136, a second side wall 138, and an intermediate wall 140. An extending wall 142 is disposed between each of second side wall 138 and intermediate wall 140. Each of a first arc face 144, a second arc face 146, a third arc face 148 are created in subsequent ones of the first and second side walls 136, 138 and intermediate wall 140 respectively. The first, second, and third arc faces 144, 146, and 148 substantially match an outer diameter of axle housing 56, providing a welding surface for first and second weld joints 78, 80. Second mounting wall 126 is created by bending a portion of second face plate 134. Similarly, both first side wall 136 and second side wall 138 are created by bending a portion of second face plate 134. After these bending operations, a first welded corner 150 and a second welded corner 152 are created to maintain the rigidity of first and second combination brackets 74, 76. Intermediate wall 140 is also bent substantially 90° from second face plate 134 followed by a bending operation to connect extending wall 142 to each of second side wall 138 and intermediate wall 140 using longitudinal weld joints 153, 153′. Retaining wall 92 is also bent to substantially contact distal ends of each of second side wall 138 and intermediate wall 140. A length of second side wall 138 is greater than a length of intermediate wall 140 to define angle α. Third and fourth welded corners 154, 156 are then created to fixedly connect retaining wall 92.

A keyed aperture 158 is created through retaining wall 92 proximate to an outward face 160 of retaining wall 92. A diameter of keyed aperture 158 is less than a diameter of cable sheath 90 but greater than a diameter of flexible cable 88 to permit flexible cable 88 to be inserted into keyed aperture 158 through outward face 160. A pin aperture 162 is also created in second face plate 134. Pin aperture 162 receives a pin (not shown) fixed on each of the first and second leaf springs 48, 50. The pin is inserted into pin aperture 162 to fix a position of the first or second leaf spring 48, 50 with respect to the appropriate one of first or second combination bracket 74, 76. Use of the pin inserted through pin aperture 162 enhances the connection provided by support plate 108.

With specific reference to FIG. 9, extending wall 142 is oriented with respect to second face plate 134 at an angle β. Angle β is selected similar to angle α to suit the corresponding installation requirements for golf car 10.

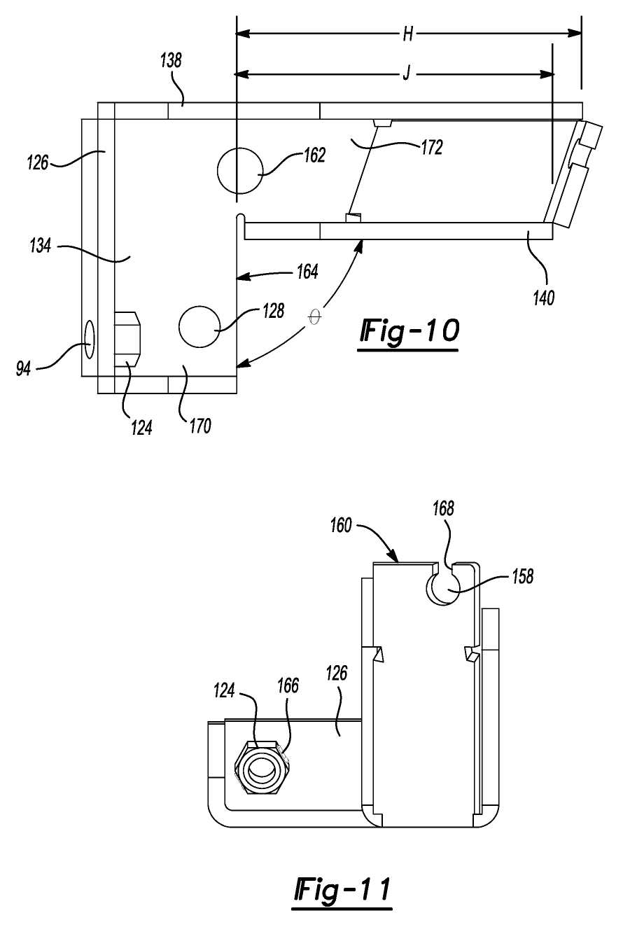

With specific reference to FIG. 10, intermediate wall 140 is oriented at an angle θ with respect to an edge 164 of second face plate 134. Angle θ is approximately 90° in several embodiments. Weld nut 124 is co-axially aligned with fastener aperture 94. Weld nut 120 is similarly co-axially aligned with its corresponding aperture. A distance “H” from edge 164 to a distal end of second side wall 138 is greater than a distance “J” from edge 164 to a distal end of intermediate wall 140. The difference between distance “H” and distance “J” determines angle α which is oriented with respect to both longitudinal axis 116 and second mounting wall 126. Also, face plate 134 further includes edge 164 defining a first portion 170 having through or alignment aperture 128. In several embodiments, a second portion 172 of face plate 134 is oriented substantially transverse to first portion 170, the second portion 172 having through or pin aperture 162.

With further reference to FIG. 11, a fillet or tack weld 166 is provided to fixedly connect nut 124 (and in a similar connection for nut 120) to second mounting wall 126. A key slot 168 is created from outward face 160 into keyed aperture 158. Key slot 168 permits the installation of flexible cable 88 into keyed aperture 158.

A combination spring, shock absorber and brake cable bracket of the present disclosure provides several advantages. By providing a pin aperture in the bracket which is welded to an axle housing, a leaf spring can be coupled to the bracket. By also providing an aperture in a first wall of the bracket, a shock absorber can be connected to the bracket. By further providing a second wall opposite to the first wall in the bracket, and orienting the second wall with respect to the first wall a flexible cable of a brake cable assembly can be supported by the second wall substantially transverse to a brake actuation arm. Still further, an alignment aperture also created in the bracket can support an assembly dolly used to support the suspension system and drive components of the golf car while the golf car is being assembled. By combining the above features in a single bracket, vehicle costs and assembly time can be reduced.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A bracket for a golf car suspension system, comprising:
a face plate;
first and second opposed side walls extending from the face plate;
a mounting wall extending from the face plate operable connected to the first and second side walls;
a nut welded to the mounting wall and coaxially aligned with a fastener aperture created in the mounting wall, the nut and the fastener aperture adapted to receive a threaded fastener; and
an arc face created in each of the first and second side walls adapted to engage an axle housing, each arc face corresponding to a diameter of the axle housing.

2. The bracket of claim 1, further comprising an extending wall extending from the face plate opposite to the mounting wall and angularly oriented with respect to both the face plate and the mounting wall.

3. The bracket of claim 2, further comprising a retaining wall positioned at distal ends of the first and second side walls.

4. The bracket of claim 3, further comprising a keyed aperture created in the retaining wall adapted to receive a flexible cable.

5. The bracket of claim 1, wherein the face plate further comprises a first portion having a first through aperture and a second portion oriented substantially transverse to the first portion, the second portion having a second through aperture.

6. The bracket of claim 1, further comprising an intermediate wall positioned between the first and second side walls.

7. A bracket for a golf car suspension system, comprising:
a face plate;
first and second opposed side walls extending from the face plate;
a mounting wall extending from the face plate operable to connect the first and second side walls;
an extending wall extending from the face plate opposite to the mounting wall and angularly oriented with respect to both the face plate and the mounting wall;
a retaining wall positioned at distal ends of the first and second side walls; and
a keyed aperture created in the retaining wall adapted to receive a flexible cable.

8. The bracket of claim 7, wherein the face plate further comprises a first portion having a first through aperture and a second portion oriented substantially transverse to the first portion, the second portion having a second through aperture.

9. The bracket of claim 8, further comprising:
an edge of the face plate; and
a first distance from the edge to a distal end of the second side wall greater than a second distance from the edge to a distal end of the intermediate wall.

10. The bracket of claim 7, further comprising a nut welded to the mounting wall and coaxially aligned with a fastener aperture created in the mounting wall, the nut and the fastener aperture adapted to receive a threaded fastener.

11. The bracket of claim 7, further comprising an arc face created in each of the first and second side walls and the intermediate wall adapted to engage an axle housing, each arc face corresponding to a diameter of the axle housing.

12. The bracket of claim 7, wherein the retaining wall defines an angle with respect to the mounting wall.

13. The bracket of claim 7, further comprising:
a first weld joint joining the first side wall to the mounting wall;
a second weld joint joining the second side wall to the mounting wall;
a third weld joint joining the second side wall to the retaining wall; and
a fourth weld joint joining the intermediate wall to the retaining wall.

14. A golf car suspension system, comprising:
first and second shock absorbers each having a mounting sleeve;
first and second brackets each configured as mirror images of each other, each of the first and second brackets including:
a face plate;
a mounting wall extending from the face plate, the mounting wall including a fastener receiving aperture alignable with the mounting sleeve of one of the shock absorbers;
an extending wall positioned opposite to the mounting wall and angularly oriented with respect to both the mounting wall and the face plate;
a retaining wall positioned at a distal end of the extending wall and oriented at an angle with respect to the mounting wall; and
a keyed aperture created in the retaining wall; and
first and second fasteners each inserted through the fastener receiving aperture of one of the first and second brackets and the mounting sleeve of one of the first and second shock absorbers.

15. The suspension system of claim 14, further comprising an axle housing divisible as each of a first housing portion and a second housing portion.

16. The suspension system of claim 15, further comprising:
a first weld joint fixedly connecting the first bracket to the first housing portion; and
a second weld joint fixedly connecting the second bracket to the second housing portion.

17. The suspension system of claim 16, further comprising opposed first and second side walls and an intermediate wall positioned between the first and second side walls, each integrally connect to and extending outwardly from the face plate.

18. The suspension system of claim 17, wherein each of the first and second side walls and the intermediate wall further comprise an arc face adapted to engage the axle housing, each arc face corresponding to a diameter of the axle housing.

19. The suspension system of claim 15, further comprising a connecting weld joint operable to fixedly connect each of the first and second side walls to the face plate.

20. The suspension system of claim 14, further comprising:
a sheath engaged with the retaining wall proximate to the keyed aperture; and
a flexible cable slidable within the sheath and having a portion extending outward of the sheath and disposed through the keyed aperture.

21. The suspension system of claim 20, further comprising:
a wheel mounting plate connected to the axle housing; and
a brake actuation arm extending from the wheel mounting plate and rotatable about an arc of rotation, the flexible cable being connected to the brake actuation arm;
wherein the angle of the retaining wall is selected to position the flexible cable substantially transverse to the brake actuation arm.

22. The suspension system of claim 14, further comprising a nut welded to the mounting wall and coaxially aligned with the fastener receiving aperture to operably receive one of the first and second fasteners.

23. A golf car, comprising:
an axle housing having first and second wheel hubs;
a brake actuation arm rotatably connected to each wheel hub;
a bracket connected to the axle housing including:
a first wall having a fastener receiving aperture; and
an opposed second wall oriented at an angle with respect to the first wall, the second wall having a keyed aperture;
a shock absorber connected by a fastener to the fastener receiving aperture; and
a cable assembly having an outer sheath engaged with the second wall and a flexible cable slidingly disposed within the outer sheath and coupled to the brake actuation arm.

24. The golf car of claim 23, further comprising:
a leaf spring;
a support plate positioned to engage the leaf spring between the support plate and the bracket; and
a U-shaped fastener positioned partially about the axle housing operable to couple the support plate and the leaf spring to the bracket.

25. The golf car of claim 24, further comprising:
a pin extending from the leaf spring; and
a pin receiving aperture created in the bracket operable to receive the pin.

26. The golf car of claim 23, further comprising:
a face plate integrally connecting the first wall to the second wall; and
an alignment aperture created in the face plate.

27. The golf car of claim 26, further comprising an assembly dolly having at least one locating pin, the locating pin engaged within the alignment aperture to orient the axle housing during assembly of the golf car.

28. The golf car of claim 23, further comprising:
at least one arc face created in the bracket configured to correspond to a diameter of the axle housing; and
at least one weld joint fixedly connecting the bracket to the axle housing proximate the arc face.

29. The golf car of claim 23, wherein the bracket further comprises first and second opposed walls extending outwardly from a plate, the first and second walls supporting the second wall at distal ends of the first and second walls.

30. The golf car of claim 23, further comprising first and second driven wheels connected to individual ones of the first and second wheel hubs.

31. A method for creating a suspension system for a golf car, the suspension system including an axle housing having first and second brake drum/hubs; a brake actuation arm rotatably connected to each brake drum/hub; a bracket including a first wall having a fastener receiving aperture, and an opposed second wall, the method comprising:
fixedly connecting the bracket to the axle housing;
fastening a shock absorber to the fastener receiving aperture;
engaging an outer sheath of a cable assembly with the second wall; and
coupling a flexible cable slidingly disposed within the outer sheath to the brake actuation arm.

32. The method of claim 31, further comprising orienting the second wall at an angle with respect to the first wall.

33. The method of claim 32, further comprising selecting the angle to orient the flexible cable substantially transversely to the brake actuation arm.

34. The method of claim 31, further comprising creating a keyed aperture in the second wall operable to receive the flexible cable.

35. The method of claim 31, further comprising connecting a nut to the first wall coaxially aligned with the fastener receiving aperture prior to the fastening step.

36. The method of claim 31, further comprising rotatably supporting first and second driven wheels each to one of the first and second brake drum/hubs.

37. The method of claim 31, further comprising connecting the shock absorber to a frame of the golf car.

38. The method of claim 31, further comprising clamping a leaf spring to the bracket.

39. The method of claim 31, further comprising:
positioning a pin aperture in the bracket; and
engaging a pin of an assembly dolly to the pin aperture.
